(19) United States
(12) Patent Application Publication
(10) Pub. No.: US 2025/0031122 A1
(43) Pub. Date: Jan. 23, 2025

(54) METHODS AND APPARATUSES FOR CONDITIONAL HANDOVER IN NON-TERRESTRIAL NETWORK

(71) Applicant: LENOVO (BEIJING) LIMITED, Beijing (CN)

(72) Inventors: Lianhai WU, Beijing (CN); Le YAN, Shanghai (CN); Min XU, Beijing (CN); Mingzeng DAI, Shanghai (CN); Haiming WANG, Beijing (CN)

(21) Appl. No.: 18/714,392

(22) PCT Filed: Nov. 30, 2021
(86) PCT No.: PCT/CN2021/134571

§ 371 Date: May 29, 2024

(51) Int. Cl. H04W 36/36; H04W 36/24

(52) U.S. Cl. CPC H04W 36/362; H04W 36/249

(57) ABSTRACT

Disclosed are methods and apparatuses for conditional handover in a non-terrestrial network (NTN). An embodiment of the subject application provides a user equipment (UE). The UE includes a processor and a wireless transceiver coupled to the processor. The processor is configured to: receive, with the wireless transceiver, at least a conditional handover (CHO) configuration and a CHO execution condition for a target cell, wherein the CHO execution condition includes: a time-based event and at least one measurement-based event, or a location-based event and at least one measurement-based event; and evaluate whether the CHO execution condition is fulfilled.

### TECHNICAL FIELD

The present disclosure generally relates to wireless communication technologies, and especially relates to methods and apparatuses for conditional handover (CHO) in a non-terrestrial network (NTN).

### BACKGROUND OF THE INVENTION

CHO plays an important role in reducing delay and interruption, ensuring business continuity during the movement of a user equipment (UE), and/or reducing the number of failure occurrences while a user is moving. In CHO, instead of preparing one target cell as in the legacy case, multiple candidate target cells are prepared in advance in the network, which enables the CHO command to be sent to a UE earlier than at normal handover when the radio conditions are still good, rather than when conditions start to get degraded as in legacy handover. Together with the command, the UE also receives a CHO configuration and a CHO execution condition to be monitored. When the CHO execution condition is fulfilled, the UE applies the previously stored CHO command, as if the network would have just sent it, instead of first sending a measurement report (that could fail to be transmitted) and then waiting to receive the command (which may fail to be received).

On the network side, the serving node can prepare one or more target “candidate” cells, as it's not certain if the UE will access a specific target cell. The CHO preparation procedure(s) has some similarities with the handover preparation procedure, and the outcome is the creation of a CHO command (i.e., an RRCReconfigurationmessage containing the target cell's configuration), except that the target node does not expect the UE to access it immediately, and in some cases, not even to access it at all.

The Mobility Robustness Optimization (MRO) function in New Radio (NR) could be enhanced to provide a more robust mobility via reporting any usable information observed during a radio link failure (RLF) or during a CHO or a handover (HO). Upon reception of this usable information, a network is able to analyze whether its mobility configuration needs adjustment. Such adjustments may result in changes of mobility configurations, such as changes of Radio Link Management (RLM) configurations or changes of mobility thresholds between a source node and a target node.

### SUMMARY

Various embodiments and methods of the present disclosure provide solutions related to CHO in a NTN.

According to some embodiments of the present disclosure, an exemplary UE is provided. The UE includes a processor; and a wireless transceiver coupled to the processor, wherein the processor is configured to: receive, with the wireless transceiver, at least a CHO configuration and a CHO execution condition for a target cell, wherein the CHO execution condition includes: a time-based event and at least one measurement-based event, or a location-based event and at least one measurement-based event; and evaluate whether the CHO execution condition is fulfilled.

In some embodiments, each of the at least one measurement-based event is CondEvent A3, CondEvent A4, or CondEvent A5.

In some embodiments, the CHO execution condition includes the time-based event and the at least one measurement-based event, the time-based event corresponds to a time window, wherein the time window is configured as: a first threshold for a beginning of the time window and a CHO timer, wherein a length of the CHO timer is equal to a length of the time window; a first threshold for a beginning of the time window and a duration of the time window; or a first threshold for a beginning of the time window and a second threshold associated with an end of the time window. In some embodiments, the time-based event is fulfilled if a current time is within the time window.

In some embodiments, in response to the fact that the time window is configured as the first threshold and the duration, the time-based vent further includes an entry condition, wherein: the entry condition for the time-based event is an inequality that a current time is greater than the first threshold and the current time is less than the first threshold plus a configured duration value.

In some embodiments, in response to the fact that the time window is configured as the first threshold and the duration, the time-based event further includes a leaving condition, wherein: the leaving condition for the time-based event is an inequality that a current time is less than the first threshold or the current time is greater than the first threshold plus the configured duration value.

In some embodiments, in response to the fact that the time window is configured as the first threshold and the second threshold, the time-based vent further includes an entry condition, wherein: the entry condition for the time-based event is an inequality that a current time is greater than the first threshold and the current time is less than the second threshold.

In some embodiments, in response to the fact that the time window is configured as the first threshold and the second threshold, the time-based event further includes a leaving condition, wherein the leaving condition for the time-based event is an inequality that a current time is less than the first threshold or the current time is greater than the second threshold.

In some embodiments, in response to the fact that the time window is configured as the first threshold for the beginning of time window and the CHO timer, the processor is further configured to: in response to the fact that a time point of receiving the first threshold is greater than the first threshold of the beginning of time window, start the CHO timer.

In some embodiments, in response to the fact that the time window is configured as the first threshold for the beginning of time window and the CHO timer, the processor is further configured to: in response to the fact that a time point of receiving the first threshold is greater than the first threshold of the beginning of time window and less than the end of the time window, start the CHO timer.

In some embodiments, in response to the fact that the time point of receiving the first threshold is greater than the first threshold of the beginning of the time window, the processor is further configured to set a length of the CHO timer as one of: a configured length of the CHO timer minus a time difference between the first threshold and the time point; and the configured length of the CHO timer.

In some embodiments, in response to the fact that the time point of receiving the first threshold is greater than the first threshold of the beginning of the time window, and less than the end of the time window, the processor is further configured to set a length of the CHO timer as one of: a configured length of the CHO timer minus a time difference between the first threshold and the time point; and the configured length of the CHO timer.

In some embodiments, in response to the fact that the time window is configured as the first threshold for the beginning of the time window and the CHO timer, the time point of receiving the first threshold is greater than the first threshold of the time window, the processor is further configured to: not starting the CHO timer, or start the CHO timer and immediately stop the CHO timer.

In some embodiments, in response to that the fact that the time window is configured as the first threshold for the beginning of the time window and the duration of the time window, or the time window is configured as the first threshold for the beginning of the time window and the second threshold associated with the end of the time window, the time-based event further includes an entry condition and/or a leaving condition.

In some embodiments, in response to the fact that the time window is configured as the first threshold for the beginning of time window and the duration of the time window, to evaluate whether the time-based event is fulfilled, the processor is further configured to: determine the time-based event is fulfilled in response to the fact that the entry condition is fulfilled and/or the leaving condition is not fulfilled.

In some embodiments, the processor is further configured to: in response to the fact that a time point of receiving the first threshold is greater than the first threshold, set the duration as one of: a configured duration value minus a time difference between the first threshold and the time point, and a configured duration value.

In some embodiments, in response to the fact that the time point of receiving the first threshold is greater than the first threshold, the processor is further configured to: ignore the CHO execution condition; and discard the CHO execution condition and keeping the CHO configuration.

In some embodiments, in response to the fact that the time point of receiving the first threshold is greater than the first threshold, the processor is further configured to: transmit, with the wireless transceiver, an indication to indicate that the time point is greater than the first threshold.

In some embodiments, the processor is further configured to: declare an RLF; perform a re-establishment procedure due to the RLF; and transmit, with the wireless transceiver, RLF information to a re-established cell, wherein the RLF information includes at least one of: an indication indicating whether at least one measurement-based event is fulfilled or not fulfilled within the time window; at least one satisfied measurement-based event within the time window; an indication indicating whether at least one measurement-based event is fulfilled or not fulfilled before the time window; an indication indicating whether at least one measurement-based event is fulfilled or not fulfilled later than the time window; an indication indicating a time difference between two measurement-based events among the at least one measurement-based event which are fulfilled within the time window in response to the fact that at least two measurement-based events are configured; or measurement results at the end of the time window.

In some embodiments, the processor is further configured to: declare an RLF; perform a re-establishment procedure due to the RLF; and transmit, with the wireless transceiver, RLF information to a re-established cell, wherein in response to the fact that the CHO execution condition includes the location-based event and the at least one measurement-based event, the RLF information includes at least one of: an indication indicating whether at least one measurement-based event is fulfilled or not fulfilled when the UE is within a configured location; at least one satisfied measurement-based event when the UE is within the configured location; an indication indicating whether at least one measurement-based event is fulfilled or not fulfilled before the UE enters the configured location; an indication indicating whether at least one measurement-based event is fulfilled after the UE leaves the configured location; an indication indicating a time difference between two measurement-based events among the at least one measurement-based event which are fulfilled when the UE is within the configured location in response to the fact that at least two measurement-based events are configured; or measurement results when the UE leaves the configured location, wherein the location-based event is fulfilled if the UE is within the configured location.

In some embodiments, the processor is further configured to receive, with the wireless transceiver, at least one SHR trigger condition to report successful handover report (SHR) after a CHO or an HO, wherein the at least one SHR trigger condition includes at least one of: a physical layer problem timer being running at a beginning of the time window; an elapsed time value of the physical layer problem timer being greater than a third threshold multiplied with a first configured value for the physical layer problem timer when the time-based event is fulfilled; a timer for initiating failure recovery based on triggering a measurement report being running at the beginning of the time window; an elapsed time value of the timer for initiating failure recovery based on triggering a measurement report being greater than a fourth threshold multiplied with a second configured value for the timer for initiating failure recovery based on triggering the measurement report when the timer-based event being fulfilled; or a time difference between two measurement-based events among the at least one measurement-based event which are fulfilled within the time window exceeding a fifth threshold in response to the fact that at least two measurement-based events are configured.

In some embodiments, the processor is further configured to: perform an HO or a CHO; and in response to that at least one trigger condition to report SHR is fulfilled, reporting the SHR to a target cell, wherein the SHR includes at least one of: an indication indicating whether the physical layer problem timer is running at the beginning of the time window; an indication indicating whether the timer for initiating failure recovery based on triggering the measurement report is running at the beginning of the time window; an indication indicating whether the physical layer problem timer is running at the end of the time window; an indication indicating whether the timer for initiating failure recovery based on triggering the measurement report is running at the end of the time window; at least one SHR condition fulfilled after the HO or the CHO is performed; an indication indicating whether the at least one measurement-based condition is fulfilled or not fulfilled within the time window; an indication indicating whether the at least one measurement-based event is fulfilled or not fulfilled before the time window; an indication indicating whether the at least one measurement-based event is fulfilled or not fulfilled after the time window; an indication indicating a time difference between two measurement-based events among the at least one measurement-based event which are fulfilled within the time window in response to the fact that at least two measurement-based events are configured; or measurement results when performing CHO or HO.

In some embodiments, the processor is further configured to receive, with the wireless transceiver, at least one SHR trigger condition to report SHR after a CHO or an HO, wherein the CHO execution condition includes the location-based event and the at least one measurement-based event, the at least one SHR trigger condition includes at least one of: a physical layer problem timer being running when entering the configured location; an elapsed time value of the physical layer problem timer being greater than a third threshold multiplied with a first configured value for the physical layer problem timer when the location-based event is fulfilled; a timer for initiating failure recovery based on triggering a measurement report being running when entering the configured location; an elapsed time value of the timer for initiating failure recovery based on triggering a measurement report being greater than a fourth threshold multiplied with a second configured value for the timer for initiating failure recovery based on triggering the measurement report when the location-based event is fulfilled; or a time difference between two measurement-based events among the at least one measurement-based event which are fulfilled within the time window exceeding a fifth threshold in response to the fact that at least two measurement-based events are configured.

In some embodiments, the processor is further configured to: perform an HO or a CHO; and in response to the fact that at least one SHR trigger condition to report SHR is fulfilled, report, with the wireless transceiver, the SHR to a target cell, wherein the SHR includes at least one of: an indication indicating whether the physical layer problem timer is running when the UE enters the configured location; an indication indicating whether the timer for initiating failure recovery based on triggering the measurement report is running when the UE enters the configured location; an indication indicting whether the physical layer problem timer is running when the UE leaves the configured location; an indication indicating whether the timer for initiating failure recovery based on triggering the measurement report is running when the UE leaves the configured location; at least one SHR condition fulfilled after the HO or the CHO is performed; an indication indicating whether the at least one measurement-based event is fulfilled or not fulfilled when the UE is within the configured location; an indication indicating at least one measurement-based event is fulfilled or not fulfilled before the UE enters the configured location; an indication indicating at least one measurement-based event is fulfilled or not fulfilled after the UE leaves the configured location; an indication indicating a time difference between two measurement-based events among the at least one measurement-based event which are fulfilled when the UE is within the configured location in response to that at least two measurement-based events are configured; or measurement results when the UE performs CHO or HO, wherein the location-based event is fulfilled if the UE is within the configured location.

According to some embodiments of the present disclosure, an exemplary base station (BS) is provided. The BS includes a processor; and a wireless transceiver coupled to the processor, wherein the processor is configured to: transmit, with the wireless transceiver, a reconfiguration message including at least a CHO configuration and a CHO execution condition for a target cell, wherein the CHO execution condition includes: a time-based event and at least one measurement-based event; or a location-based event and at least one measurement-based event.

In some embodiments, each of the at least one measurement-based event is CondEvent A3, CondEvent A4, or CondEvent A5.

In some embodiments, the CHO execution condition includes the time-based event and the at least one measurement-based event, the time-based event is fulfilled if a current time is within a time window, wherein the time window is configured as: a first threshold and a CHO timer with a length; a first threshold and a duration; or a first threshold and a second threshold.

In some embodiments, the processor is further configured to: receive, with the wireless transceiver, an indication indicating that a time point where the UE receives the first threshold is later than the first threshold.

In some embodiments, the processor is further configured to transmit, with the wireless transceiver, at least one SHR trigger condition to report SHR after a CHO or an HO, wherein the at least one SHR trigger condition to report SHR includes at least one of: a physical layer problem timer being running at a beginning of the time window; an elapsed time value of the physical layer problem timer being greater than a third threshold multiplied with a first configured value for the physical layer problem timer when the time-based event is fulfilled; a timer for initiating failure recovery based on triggering a measurement report being running at the beginning of time window; an elapsed time value of the timer for initiating failure recovery based on triggering a measurement report being greater than a fourth threshold multiplied with a second configured value for the timer for initiating failure recovery based on triggering the measurement report when the time-based event is fulfilled; or a time difference between two measurement-based events among the at least one measurement-based event which are fulfilled within the time window exceeding a fifth threshold in response to the fact that at least two measurement-based events are configured.

In some embodiments, the processor is further configured to transmit, with the wireless transceiver, at least one SHR trigger condition to report SHR after a CHO or an HO, wherein the CHO execution condition includes the location-based event and the at least one measurement-based event, the at least one SHR trigger condition to report SHR includes at least one of: a physical layer problem timer being running when entering the configured location; an elapsed time value of the physical layer problem timer being greater than a third threshold multiplied with a first configured value for the physical layer problem timer when the location-based event is fulfilled; a timer for initiating failure recovery based on triggering a measurement report being running when entering the configured location; an elapsed time value of the timer for initiating failure recovery based on triggering a measurement report being greater than a fourth threshold multiplied with a second configured value for the timer for initiating failure recovery based on triggering the measurement report when the location-based event is fulfilled; or a time difference between two measurement-based events among the at least one measurement-based event which are fulfilled within the time window exceeding a fifth threshold in response to the fact that at least two measurement-based events are configured.

According to some embodiments of the present disclosure, an exemplary method performed by a UE is provided. The method includes: receiving at least a conditional handover (CHO) configuration and a CHO execution condition for a target cell, wherein the CHO execution condition includes: a time-based event and at least one measurement-based event, or a location-based event and at least one measurement-based event; and evaluating whether the CHO execution condition is fulfilled.

In some embodiments, each of the at least one measurement-based event is CondEvent A3, CondEvent A4, or CondEvent A5.

In some embodiments, the CHO execution condition includes the time-based event and the at least one measurement-based event, the time-based event corresponds to a time window, wherein the time window is configured as: a first threshold for a beginning of the time window and a CHO timer, wherein a length of the CHO timer is equal to a length of the time window; a first threshold for a beginning of the time window and a duration of the time window; or a first threshold for a beginning of the time window and a second threshold associated with an end of the time window. In some embodiments, the time-based event is fulfilled if a current time is within the time window.

In some embodiments, in response to the fact that the time window is configured as the first threshold and the duration, the time-based event further includes an entry condition wherein: the entry condition for the time-based event is an inequality that a current time is greater than the first threshold and the current time is less than the first threshold plus a configured duration value.

In some embodiments, in response to the fact that the time window is configured as the first threshold and the duration, the time-based event further includes a leaving condition, wherein: the leaving condition for the time-based event is an inequality that a current time is less than the first threshold or the current time is greater than the first threshold plus the configured duration value.

In some embodiments, in response to the fact that the time window is configured as the first threshold and the second threshold, the time-based event further includes an entry condition, wherein: an entry condition for the time-based event is an inequality that a current time is greater than the first threshold and the current time is less than the second threshold.

In some embodiments, in response to the fact that the time window is configured as the first threshold and the second threshold, the time-based event further includes a leaving condition, wherein: the leaving condition for the time-based event is an inequality that a current time is less than the first threshold or the current time is greater than the second threshold.

In some embodiments, in response to the fact that the time window is configured as the first threshold for the beginning of time window and the CHO timer, the method further includes: in response to the fact that a time point of receiving the first threshold is greater than the first threshold of the beginning of time window, starting the CHO timer.

In some embodiments, in response to the fact that the time window is configured as the first threshold for the beginning of time window and the CHO timer, the method further includes: in response to the fact that a time point of receiving the first threshold is greater than the first threshold of the beginning of time window and less than the end of the time window, starting the CHO timer.

In some embodiments, in response to the fact that a time point of receiving the first threshold is greater than the first threshold of the beginning of the time window, the method further includes setting a length of the CHO timer as one of: a configured length of the CHO timer minus a time difference between the first threshold and the time point; and the configured length of the CHO timer.

In some embodiments, in response to the fact that a time point of receiving the first threshold is greater than the first threshold of the beginning of the time window and less than the end of the time window, the method further includes setting a length of the CHO timer as one of: a configured length of the CHO timer minus a time difference between the first threshold and the time point; and the configured length of the CHO timer.

In some embodiments, in response to the fact that the time window is configured as the first threshold for the beginning of the time window and the CHO timer, and that the time point of receiving the first threshold is greater than the first threshold of the time window, the method further includes: not starting the CHO timer, or starting the CHO timer and immediately stopping the CHO timer.

In some embodiments, in response to that the fact that the time window is configured as the first threshold for the beginning of the time window and the duration of the time window, or the time window is configured as the first threshold for the beginning of the time window and the second threshold associated with the end of the time window, the time-based event further includes an entry condition and/or a leaving condition.

In some embodiments, evaluating whether the time-based event is fulfilled further includes: determining the time-based event is fulfilled in response to the fact that the entry condition is fulfilled and/or the leaving condition is not fulfilled.

In some embodiments, the method further includes: in response to the fact that a time point of receiving the first threshold is greater than the first threshold, setting the duration as one of: a configured duration value minus a time difference between the first threshold and the time point, and a configured duration value.

In some embodiments, in response to the fact that the time point of receiving the first threshold is greater than the first threshold, the method further includes: ignoring the CHO execution condition; and discarding the CHO execution condition and keeping the CHO configuration.

In some embodiments, in response to the fact that the time point of receiving the first threshold is greater than the first threshold, the method further includes: transmitting an indication to indicate that the time point is greater than the first threshold.

In some embodiments, the method further includes: declaring an RLF; performing a re-establishment procedure due to the RLF; and transmitting RLF information to a re-established cell, wherein the RLF information includes at least one of: an indication indicating whether at least one measurement-based event is fulfilled or not fulfilled within the time window; at least one satisfied measurement-based event within the time window; an indication indicating whether at least one measurement-based event is fulfilled or not fulfilled before the time window; an indication indicating whether at least one measurement-based event is fulfilled or not fulfilled later than the time window; an indication indicating a time difference between two measurement-based events among the at least one measurement-based event which are fulfilled within the time window in response to the fact that at least two measurement-based events are configured; or measurement results at the end of the time window.

In some embodiments, the method further includes: declaring an RLF; performing a re-establishment procedure due to the RLF; and transmitting RLF information to a re-established cell, wherein in response to the fact that the CHO execution condition includes the location-based event and the at least one measurement-based event, the RLF information includes at least one of: an indication indicating whether at least one measurement-based event is fulfilled or not fulfilled when the UE is within a configured location; at least one satisfied measurement-based event when the UE is within the configured location; an indication indicating whether at least one measurement-based event is fulfilled or not fulfilled before the UE enters the configured location; an indication indicating whether at least one measurement-based event is fulfilled after the UE leaves the configured location; an indication indicating a time difference between two measurement-based events among the at least one measurement-based event which are fulfilled when the UE is within the configured location in response to the fact that at least two measurement-based events are configured; or measurement results when the UE leaves the configured location, wherein the location-based event is fulfilled if the UE is within the configured location.

In some embodiments, the method further includes receiving at least one SHR trigger condition to report SHR after a CHO or an HO, wherein the at least one SHR trigger condition includes at least one of: a physical layer problem timer being running at a beginning of the time window; an elapsed time value of the physical layer problem timer being greater than a third threshold multiplied with a first configured value for the physical layer problem timer when the time-based event is fulfilled; a timer for initiating failure recovery based on triggering a measurement report being running at the beginning of the time window; an elapsed time value of the timer for initiating failure recovery based on triggering a measurement report being greater than a fourth threshold multiplied with a second configured value for the timer for initiating failure recovery based on triggering the measurement report when the timer-based event being fulfilled; or a time difference between two measurement-based events among the at least one measurement-based event which are fulfilled within the time window exceeding a fifth threshold in response to the fact that at least two measurement-based events are configured.

In some embodiments, the method further includes performing an HO or a CHO; in response to that at least one SHR trigger condition to report SHR is fulfilled, reporting the SHR to a target cell, wherein the SHR includes at least one of: an indication indicating whether the physical layer problem timer is running at the beginning of the time window; an indication indicating whether the timer for initiating failure recovery based on triggering the measurement report is running at the beginning of the time window; an indication indicating whether the physical layer problem timer is running at the end of the time window; an indication indicating whether the timer for initiating failure recovery based on triggering the measurement report is running at the end of the time window; at least one SHR condition fulfilled after the HO or the CHO is performed; an indication indicating whether the at least one measurement-based condition is fulfilled or not fulfilled within the time window; an indication indicating whether the at least one measurement-based event is fulfilled or not fulfilled before the time window; an indication indicating whether the at least one measurement-based event is fulfilled or not fulfilled after the time window; an indication indicating a time difference between two measurement-based events among the at least one measurement-based event which are fulfilled within the time window in response to the fact that at least two measurement-based events are configured; or measurement results when performing CHO or HO.

In some embodiments, the method further includes receiving at least one SHR trigger condition to report SHR after a CHO or an HO, wherein the CHO execution condition includes the location-based event and the at least one measurement-based event, the at least one SHR trigger condition includes at least one of: a physical layer problem timer being running when entering the configured location; an elapsed time value of the physical layer problem timer being greater than a third threshold multiplied with a first configured value for the physical layer problem timer when the location-based event is fulfilled; a timer for initiating failure recovery based on triggering a measurement report being running when entering the configured location; an elapsed time value of the timer for initiating failure recovery based on triggering a measurement report being greater than a fourth threshold multiplied with a second configured value for the timer for initiating failure recovery based on triggering the measurement report when the location-based event is fulfilled; or a time difference between two measurement-based events among the at least one measurement-based event which are fulfilled within the time window exceeding a fifth threshold in response to the fact that at least two measurement-based events are configured.

In some embodiments, the method further includes: performing an HO or a CHO; in response to the fact that at least one SHR trigger condition to report SHR is fulfilled, reporting the SHR to a target cell, wherein the SHR includes at least one of: an indication indicating whether the physical layer problem timer is running when the UE enters the configured location; an indication indicating whether the timer for initiating failure recovery based on triggering the measurement report is running when the UE enters the configured location; an indication indicting whether the physical layer problem timer is running when the UE leaves the configured location; an indication indicating whether the timer for initiating failure recovery based on triggering the measurement report is running when the UE leaves the configured location; at least one SHR condition fulfilled after the HO or the CHO is performed; an indication indicating whether the at least one measurement-based event is fulfilled or not fulfilled when the UE is within the configured location; an indication indicating at least one measurement-based event is fulfilled or not fulfilled before the UE enters the configured location; an indication indicating at least one measurement-based event is fulfilled or not fulfilled after the UE leaves the configured location; an indication indicating a time difference between two measurement-based events among the at least one measurement-based event which are fulfilled when the UE is within the configured location in response to that at least two measurement-based events are configured; or measurement results when the UE performs CHO or HO, wherein the location-based event is fulfilled if the UE is within the configured location.

According to some embodiments of the present disclosure, an exemplary method performed by a BS is provided. The method includes transmitting a reconfiguration message including at least a conditional handover (CHO) configuration and a CHO execution condition for a target cell, wherein the CHO execution condition includes: a time-based event and at least one measurement-based event; or a location-based event and at least one measurement-based event.

In some embodiments, each of the at least one measurement-based event is CondEvent A3, CondEvent A4, or CondEvent A5.

In some embodiments, the CHO execution condition includes the time-based event and the at least one measurement-based event, the time-based event is fulfilled if a current time is within a time window, wherein the time window is configured as: a first threshold and a CHO timer with a length; a first threshold and a duration; or a first threshold and a second threshold.

In some embodiments, the method further includes receiving an indication indicating that a time point where the UE receives the first threshold is later than the first threshold.

In some embodiments, the method further includes transmitting at least one SHR trigger condition to report SHR after a CHO or an HO, wherein the at least one SHR trigger condition to report SHR includes at least one of: a physical layer problem timer being running at a beginning of the time window; an elapsed time value of the physical layer problem timer being greater than a third threshold multiplied with a first configured value for the physical layer problem timer when the time-based event is fulfilled; a timer for initiating failure recovery based on triggering a measurement report being running at the beginning of time window; an elapsed time value of the timer for initiating failure recovery based on triggering a measurement report being greater than a fourth threshold multiplied with a second configured value for the timer for initiating failure recovery based on triggering the measurement report when the time-based event is fulfilled; or a time difference between two measurement-based events among the at least one measurement-based event which are fulfilled within the time window exceeding a fifth threshold in response to the fact that at least two measurement-based events are configured.

In some embodiments, the method further includes transmitting at least one trigger condition to report SHR after a CHO or an HO, wherein the CHO execution condition includes the location-based event and the at least one measurement-based event, the at least one trigger condition to report SHR includes at least one of: a physical layer problem timer being running when entering the configured location; an elapsed time value of the physical layer problem timer being greater than a third threshold multiplied with a first configured value for the physical layer problem timer when the location-based event is fulfilled; a timer for initiating failure recovery based on triggering a measurement report being running when entering the configured location; an elapsed time value of the timer for initiating failure recovery based on triggering a measurement report being greater than a fourth threshold multiplied with a second configured value for the timer for initiating failure recovery based on triggering the measurement report when the location-based event is fulfilled; or a time difference between two measurement-based events among the at least one measurement-based event which are fulfilled within the time window exceeding a fifth threshold in response to the fact that at least two measurement-based events are configured.

### BRIEF DESCRIPTION OF THE DRAWINGS

In order to describe the manner in which advantages and features of the present disclosure can be obtained, a description of the present disclosure is rendered by reference to specific embodiments thereof which are illustrated in the appended drawings. These drawings depict only exemplary embodiments of the present disclosure and are not therefore intended to limit the scope of the present disclosure.

FIG. 1 illustrates an exemplary flowchart of a method performed by a UE according to some embodiments of the present disclosure;

FIG. 2 (including (a), (b), and (c)) illustrates an exemplary time window configuration according to some embodiments of the present disclosure;

FIG. 3 (including (a), (b), and (c)) illustrates an exemplary time window configuration according to some embodiments of the present disclosure;

FIG. 4 (including (a) and (b)) illustrates an exemplary time window configuration according to some embodiments of the present disclosure;

FIG. 5 illustrates an exemplary flowchart of a method performed by a UE according to some embodiments of the present disclosure;

FIG. 6 illustrates an exemplary RLF according to some embodiments of the present disclosure;

FIG. 7 illustrates an exemplary flowchart of a method performed by a UE according to some embodiments of the present disclosure;

FIG. 8 illustrates an exemplary SHR according to some embodiments of the present disclosure;

FIG. 9 illustrates an exemplary flowchart of a method performed by a source BS according to some embodiments of the present disclosure;

FIG. 10 illustrates a simplified block diagram of an exemplary UE or BS according to some other embodiments of the present disclosure.

### DETAILED DESCRIPTION

The detailed description of the appended drawings is intended as a description of the currently preferred embodiments of the present invention and is not intended to represent the only form in which the present invention may be practiced. It should be understood that the same or equivalent functions may be accomplished by different embodiments that are intended to be encompassed within the spirit and scope of the present invention.

While operations are depicted in the drawings in a particular order, persons skilled in the art will readily recognize that such operations need not be performed in the particular order shown or in sequential order, or that among all illustrated operations be performed, to achieve desirable results, sometimes one or more operations can be skipped. Further, the drawings can schematically depict one or more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing can be advantageous.

Reference will now be made in detail to some embodiments of the present disclosure, examples of which are illustrated in the accompanying drawings. To facilitate understanding, embodiments are provided under specific network architecture and new service scenarios, such as 3GPP 5G NR, 3GPP long-term evolution (LTE), and so on. It is contemplated that along with the developments of network architectures and new service scenarios, all embodiments in the present disclosure are also applicable to similar technical problems; and moreover, the terminologies recited in the present disclosure may change, which should not affect the principle of the present disclosure.

In some embodiments of the present disclosure, UEs may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like. According to an embodiment of the present disclosure, the UE may include a portable wireless communication device, a smart phone, a cellular telephone, a flip phone, a device having a subscriber identity module, a personal computer, a selective call receiver, or any other device that is capable of sending and receiving communication signals on a wireless network. In some embodiments, the UE may include wearable devices, such as smart watches, fitness bands, optical head-mounted displays, or the like. Moreover, the UE may be referred to as a subscriber unit, a mobile, a mobile station, a user, a terminal, a mobile terminal, a wireless terminal, a fixed terminal, a subscriber station, a user terminal, or a device, or described using other terminology used in the art.

In some embodiments of the present disclosure, a BS may be referred to as an access point, an access terminal, a base, a base unit, a macro cell, a wireless node, a Node-B, an enhanced Node-B, an evolved Node B (eNB), a next generation Node B (gNB), a Home Node-B, a relay node, or a device, or described using other terminology used in the art. The BS is generally part of a radio access network that may include a controller communicably coupled to the BS.

The present disclosure provides various methods and embodiment about CHO in NTN, and logging information for MRO.

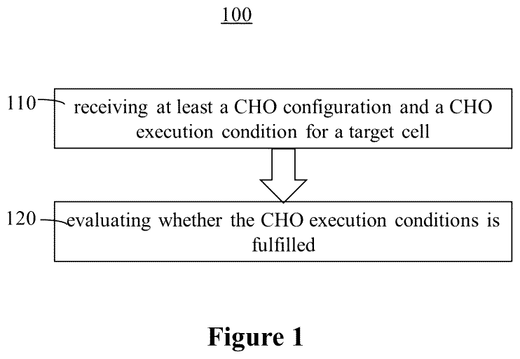

FIG. 1 illustrates an exemplary flowchart of method 100 performed by a UE according to some embodiments of the present disclosure. It would be appreciated that in method 100 or in other methods described later, the UE is not a special UE; it can be a generic device or an apparatus, or a part of a device or an apparatus that uses the technical solution of the present application.

In operation 110, the UE receives at least a CHO configuration and a CHO execution condition for a target cell. In some embodiments, the CHO execution condition includes a time-based event and at least one measurement-based event. In some embodiments, the CHO execution condition includes a location-based event and at least one measurement-based event.

In some embodiments, the UE receives the CHO execution condition via a message, for example, a Radio Resource Control (RRC) reconfiguration message (e.g., RRCReconfiguration).

In operation 120, the UE evaluates whether the CHO execution condition is fulfilled.

In some embodiments, the CHO execution condition includes a time-based event and at least one measurement-based event, the UE determines that the CHO execution condition is fulfilled only when both the time-based event and the at least one measurement-based event are fulfilled; wherein, if the at least one measurement-based events includes more than one measurement-based events, then the at least one measurement-based event is determined to be fulfilled only when all of the more than one measurement-based events are fulfilled simultaneously.

In some embodiments, the CHO execution condition includes a location-based event and at least one measurement-based event, the UE determines that the CHO execution condition is fulfilled only when both the location-based event and the at least one measurement-based event are fulfilled; wherein, if the at least one measurement-based events includes more than one measurement-based events, then the at least one measurement-based event is determined to be fulfilled only when all of the more than one measurement-based events are fulfilled simultaneously.

In some embodiment, each of the at least one measurement-based event is CondEvent A3, CondEvent A4, or CondEvent A5.

For example, the at least one measurement-based event may include only one measurement-based event, and the measurement-based event is a CondEvent A3, a CondEvent A4, or a CondEvent A5.

For example, the at least one measurement-based event may include two measurement-based events, and the two measurement-based events may be a CondEvent A3 and a CondEvent A5.

For example, the at least one measurement-based event may include two measurement-based events, and the two measurement-based events may be a CondEvent A3 based on Reference Signal Received Power (RSRP) and a CondEvent A3 based on a ratio between RSRP and Received Signal Strength Indication (RSSI).

In some embodiment, method 100 further includes performing a CHO according to the received CHO configuration if the CHO execution condition is fulfilled.

In some cases, the CHO execution condition includes a time-based event and at least one measurement-based event, the time-based event corresponds to a time window, and the time-based event is fulfilled if a current time is within the time window.

In some embodiments, the time window is in universal time (UTC) format.

In some embodiments, the UE may perform CHO according to a received CHO configuration if the at least one measurement-based event is fulfilled within the time window.

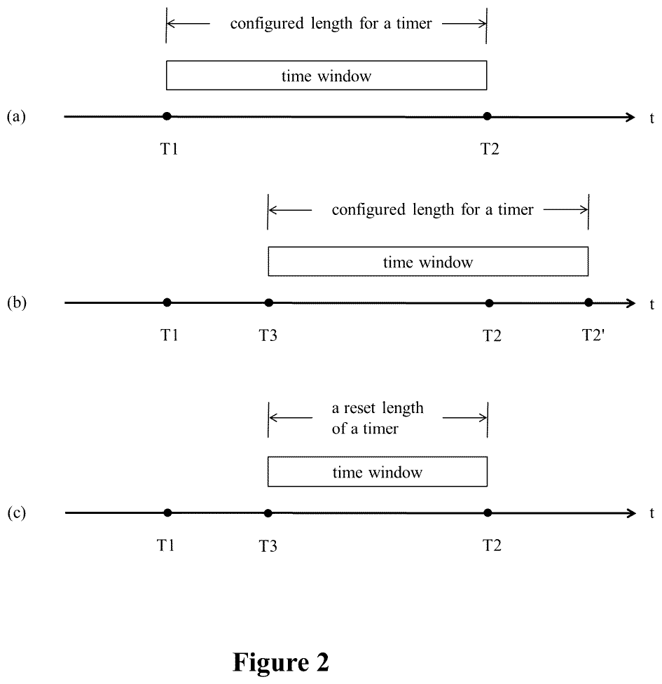

In some embodiments, the time window is configured as a first threshold (T1) for a beginning of the time window and a CHO timer, wherein the length of the timer is equal to the length of the time window as illustrated in FIG. 2(a), wherein the CHO timer has a configured length.

In some embodiments, the UE receives the first threshold (T1) and the configured length via a message, e.g., an RRC reconfiguration message.

As shown in FIG. 2(a), the length of the time window is the configured length of the CHO timer. The CHO timer begins to run at T1 and expires at T2 (i.e., T1+the configured length of the CHO timer). The time window is between T1 and T2, and the time-based event is fulfilled when the CHO timer runs in the time window.

However, in some embodiments, there may be a time delay between the transmission of T1 (or a message containing T1) from a BS and the reception of the T1 (or the message containing T1) by the UE, for example, when a UE is in a NTN and there may be long distance between the UE and the satellite in the NTN, when the UE receives T1 at time point T3, T3 may be already greater than T1, or even greater than T2.

In such case that time point T3 is greater than T1 (or even greater than T2), in some embodiments, the UE may still start the CHO timer, and the time still runs with the configured length, as illustrated in FIG. 2(b). In this example, T2′=(T3+the configured length of the CHO timer), and the time window is between T3 and T2′. The length of the time window is the configured length of the CHO timer. Although in FIG. 2(b), T3 is between T1 and T2, it is appreciated that the solution illustrated in FIG. 2(b) may be applied even when T3 is greater than T2. The CHO execution condition is determined to be fulfilled if the at least one measurement-based event is fulfilled within the time window.

In some embodiments, if T3 is greater than T1 and less than T2, the UE may reset the length of the CHO timer as the configured length minus a time difference between T1 and T3, and start the CHO timer at T3, as illustrated in FIG. 2(c). The CHO timer still expires at T2; the time window is between T3 and T2, and the length of the time window is the reset length of the CHO timer. The CHO execution condition is determined to be fulfilled if the at least one measurement-based event is fulfilled within the time window.

In some cases that T3 is greater than T2, the UE may not starting the CHO timer; and the time-based event is determined to be never fulfilled.

In some cases that T3 is greater than T2, the UE may start the CHO timer but immediately stop the CHO timer; and the time-based event is determined to be never fulfilled.

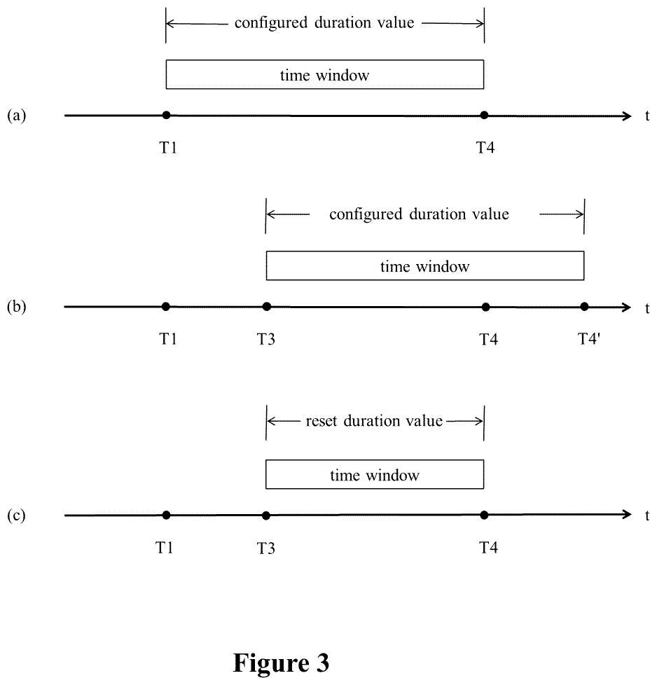

In some embodiments, the time window is configured as a first threshold (T1) for a beginning of the time window and a duration of the time window, as illustrated in FIG. 3(a), wherein the duration value of the duration is a configured duration value.

In some embodiments, the UE receives the first threshold (T1) and the configured duration value via a message, e.g., an RRC reconfiguration message.

As shown in FIG. 3(a), the duration begins at T1 and ends at T4 (i.e., T1+the configured duration value). The time window is between T1 and T4, the length of the time window is the configured duration value, and the time-based event is fulfilled when a current time is within the time window.

However, in some embodiments, there may be a time delay between the transmission of T1 (or a message containing T1) from a BS and the reception of T1 (or the message containing T1) by the UE, for example, when a UE is in a NTN and there may be long distance between the UE and the satellite in the NTN, when the UE receives T1 at time point T3, T3 may be already greater than T1, or even greater than T4.

In some cases that time point T3 when receiving the time-based event is greater than T1 (or even greater than T4), in some embodiments, the UE may still set the duration value as the configured duration value, as illustrated in FIG. 3(b), the duration begins at T3, and ends at T4′ (i.e., T1+the configured duration value). The time window is between T3 and T4′, the length of the time window is still the configured duration value of the CHO timer. In FIG. 3(b), T3 is between T1 and T4; however, it is appreciated that the solution illustrated in FIG. 3(b) may be applied for the case that T3 is greater than T4. The CHO execution condition is determined to be fulfilled if the at least one measurement-based event is fulfilled within the time window.

In some cases that T3 is greater than T1 and less than T4, the UE may reset the duration value of the duration as the configured duration value minus a time difference between T1 and T3, as illustrated in FIG. 3(c). The time window is between T3 and T4, the length of the time window is the reset duration value. The CHO execution condition is determined to be fulfilled if the at least one measurement-based event is fulfilled within the time window.

In the cases that the time window is configured as the first threshold for the beginning of the time window and a duration of the time window, the time-based event may further include an entry condition, wherein the entry condition is indicated by inequality (1) or inequality (1′) that a current time is greater than the first threshold (i.e., T1) and the current time is less than the first threshold plus the configured duration value (i.e. T4); in other words, the entry condition is that a current time is within the time window illustrated in FIG. 3(a):

$$Mt > T 1 and Mt < T 1 + d 1 or \qquad ( 1 )$$

$$Mt > T 1 and Mt < T 4 \qquad ( {1}^{′} )$$

wherein:
Mt: a current time or a time measured at the UE; and
d1: a configured duration value, and T4=T1+d1.

In the cases that the time window is configured as the first threshold for the beginning of the time window and a duration of the time window, the time-based event may further include a leaving condition, wherein the leaving condition is indicated by inequality (2) or inequality (2′) that the current time is less than the first threshold or the current time is greater than the first threshold plus a configured duration value (i.e., T4). In other words, the leaving condition is that a current time is before the time window illustrated in FIG. 3(a) or later than the time window illustrated in FIG. 3(a):

$$Mt < T 1 or Mt > T 1 + d 1 or \qquad ( 2 )$$

$$Mt < T 1 or Mt > T 4 \qquad ( {2}^{′} )$$

wherein:
Mt: a current time or a time measured at the UE; and
d1: a configured duration value, and T4=T1+d1.

The time-based event is fulfilled if the entry condition is fulfilled and/or the leaving condition is not fulfilled. The time-based event is not fulfilled if the entry condition is not fulfilled and/or the leaving condition is fulfilled.

However, in some embodiments, there may be a time delay between the transmission of T1 (or a message containing T1) from a BS and the reception of T1 (or the message containing T1) by the UE, for example, the UE receives T1 at time point T3, and T3 may be already greater than T1, or even greater than T4 (e.g., as shown in FIG. 3(b) or FIG. 3(c)).

In such cases, the entry condition and the leaving condition for the time-based event may be adjusted.

For example, regarding the example illustrated in FIG. 3(a), the entry condition is that a current time is greater than T1 and before T4; the leaving condition is that a current time is before T1 or greater than T4.

For example, regarding the example illustrated in FIG. 3(b), the entry condition is that a current time is greater than T3 and before T4′; the leaving condition is that a current time is before T3 or greater than T4′.

For example, regarding the example illustrated in FIG. 3(c), the entry condition is that a current time is greater than T3 and before T4; the leaving condition is that a current time is before T3 or greater than T4.

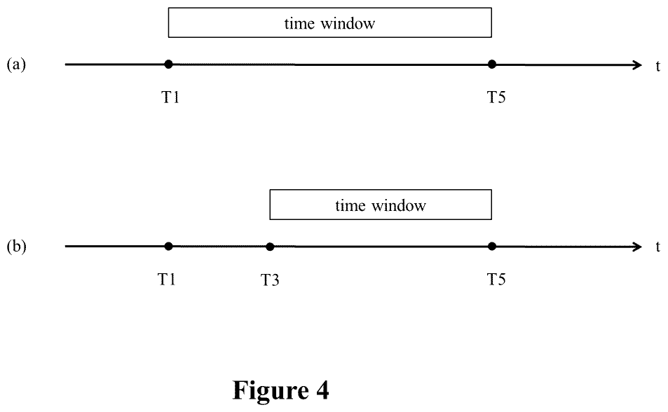

In some embodiments, the time window is configured as a first threshold (T1) for the beginning of the time window and a second threshold (T5) associated with an end of the time window, as illustrated in FIG. 4(a), wherein the time window is between T1 and T5, and the length of the time window is a time difference between T1 and T5. The time-based event is fulfilled when a current time is within the time window.

In some embodiments, the UE receives the first threshold (T1) and the second threshold (T5) via a message, e.g., an RRC reconfiguration message.

However, in some embodiments, there may be a time delay between the transmission of the two thresholds (or a message containing the two thresholds) from a BS and the reception of the two thresholds (or the message containing the two thresholds) by the UE, for example, when a UE is in a NTN and there may be long distance between the UE and the satellite in the NTN, when the UE receives the two thresholds (or a message containing the two thresholds) at time point T3, T3 may be already greater than T1, or even greater than T5.

In some cases that T3 is greater than T1 and less than T5, in some embodiments, the UE may set the time window to be between T3 and T5, as illustrated in FIG. 4(b). The time window is between T3 and T5, and the length of the time window is the time difference between T3 and T5. The CHO execution condition is determined to be fulfilled if the at least one measurement-based event is fulfilled within the time window.

In some cases that T3 is greater than T5, the UE may determine that the time-based event is not met; in other words, the CHO execution condition will be determined to be not fulfilled.

In the cases the cases that the time window is configured as a first threshold for the beginning of the time window and a second threshold associated with an end of the time window, the time-based event may further include an entry condition, wherein the entry condition is indicated in inequality (3) that an current time is greater than the first threshold (i.e., T1) and the current time is less than the second threshold (i.e., T5); in other words, the entry condition is that a current time is within the time window illustrated in FIG. 4(a):

$$Mt > T 1 and Mt < T 5 \qquad ( 3 )$$

wherein Mt: a current time or a time measured at the UE.

In the cases that the time window is configured as a first threshold for the beginning of the time window and a second threshold associated with an end of the time window, the time-based event may include a leaving condition, wherein the leaving condition is indicated in inequality (4) that the current time is less than the first threshold (i.e., T1) or the current time is greater than the second threshold (i.e., T5). In other words, the leaving condition is that a current time is before the time window as illustrated in FIG. 4(a) or later than the time window illustrated in FIG. 4(a):

$$Mt < T 1 or Mt > T 5 \qquad ( 4 )$$

wherein Mt: a current time or a time measured at the UE.

The time-based event is fulfilled if the entry condition is fulfilled and/or the leaving condition is not fulfilled. The time-based event is not fulfilled if the entry condition is not fulfilled and/or the leaving condition is fulfilled.

However, in some embodiments, there may be a time delay between the transmission of T1 (or a message containing T1) from a BS and the reception of T1 (or the message containing T1) by the UE, for example, the UE receives T1 at time point T3, and T3 may be already greater than T1, or even greater than T5 (e.g., as shown in FIG. 4(b)).

In such cases, the entry condition and the leaving condition for the time-based event may be adjusted.

For example, regarding the example illustrated in FIG. 4(a), the entry condition is that a current time is greater than T1 and before T5; the leaving condition is that a current time is before T1 or greater than T5.

For example, regarding the example illustrated in FIG. 4(b), the entry condition is that a current time is greater than T3 and before T5; the leaving condition is that a current time is before T3 or greater than T5.

In some embodiments, no matter what kind of the configuration of the time window, if the time point of receiving the time-based event is greater than the first threshold (i.e., T1), the UE may ignore the at least one received CHO execution conditions or even discard the at least one received CHO execution condition. In some embodiment, the UE may keep the received CHO configuration for possible further use.

In some embodiments, if the time point of receiving the time-based event is greater than the first threshold, the UE may transmit an indication to a BS indicating that the time point receiving the time-based event is greater than the first threshold. In some embodiments, the UE receives the time-based event via an RRC Reconfiguration message, and then the indication indicates that the time point (e.g., T3) receiving the RRC Reconfiguration message is greater than the first threshold; the network may make some corresponding adjustment to avoid such case.

In some embodiments, the indication indicating that the time point receiving the time-based event is greater than the first threshold is transmitted via an RRC Reconfiguration complete message.

In some embodiments, the CHO execution condition includes a location-based event and at least one measurement-based event. The location-based event is fulfilled if the UE stays within a configured location. If the at least one measurement-based event is fulfilled when the UE is in a configured location, the CHO execution condition is fulfilled.

In some embodiments, the UE may perform CHO according to a received CHO configuration if the at least one measurement-based event is fulfilled when the UE is within the configured location.

According to the present disclosure, if the UE evaluates that the CHO execution condition is met, the UE may perform CHO according to a received CHO configuration for a target cell.

However, if an RLF occurs, the UE will not perform a CHO; the UE may access a new cell by re-establishment or connection setup. The UE may stores the latest RLF report until the RLF report is fetched by a network or the UE may keep the latest RLF report for 48 hours. Once the UE enters a connected state, the re-established cell may transmit a UE information request to the UE, and the UE may transmit a UE information response including the RLF report to the re-established cell. The re-established cell may forward the RLF report to the last serving cell (or the source cell) for the UE. Finally, the RLF report may be under analysis; and the network may optimize the mobility thereby; in other word, the RLF report may be used for MRO.

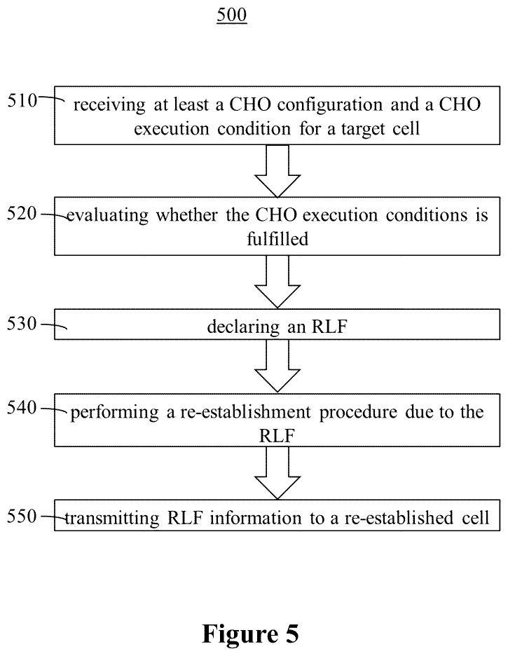

FIG. 5 illustrates method 500 performed by a UE based on method 100 according to some embodiments of the present disclosure. It would be appreciated that in method 500, the UE is not a special UE; it can be a generic device or an apparatus, or a part of a device or an apparatus that uses the technical solution of the present application.

In operation 510, the UE receives at least a CHO configuration and a CHO execution condition for a target cell. In some embodiments, the CHO execution condition includes a time-based event and at least one measurement-based event. In some embodiments, the CHO execution condition includes a location-based event and at least one measurement-based event.

In some embodiments, the UE receives the CHO execution condition via a message, for example, a Radio Resource Control (RRC) reconfiguration message (e.g., RRCReconfiguration).

In operation 520, the UE evaluates whether the CHO execution condition is fulfilled.

In some embodiments, the CHO execution condition includes a time-based event and at least one measurement-based event, the UE determines that the CHO execution condition is fulfilled only when both the time-based event and the at least one measurement-based event are fulfilled; wherein, if the at least one measurement-based events includes more than one measurement-based events, then the at least one measurement-based event is determined to be fulfilled only when all of the more than one measurement-based events are fulfilled simultaneously.

In some embodiments, the CHO execution condition includes a location-based event and at least one measurement-based event, the UE determines that the CHO execution condition is fulfilled only when both the location-based event and the at least one measurement-based event are fulfilled; wherein, if the at least one measurement-based events includes more than one measurement-based events, then the at least one measurement-based event is determined to be fulfilled only when all of the more than one measurement-based events are fulfilled simultaneously.

In operation 530, if an RLF occurs, for example, before the CHO execution condition is fulfilled, the UE declares an RLF.

In operation 540, the UE performs a re-establishment procedure due to the RLF.

In operation 550, the UE transmits RLF information to a re-established cell.

In some cases, in operation 510, the CHO execution condition includes a time-based event and at least one measurement-based event; the time-based event is fulfilled if a current time is within a configured time window.

In some embodiments, the RLF information includes at least an indication indicating whether the at least one measurement-based event is fulfilled or not fulfilled within the time window.

In some embodiments, the RLF information includes at least at least one satisfied measurement-based event within the time window.

In some embodiments, the RLF information includes at least an indication indicating whether at least one measurement-based event is fulfilled or not fulfilled before the time window.

In some embodiments, the RLF information includes at least an indication indicating whether at least one measurement-based event is fulfilled or not fulfilled later than the time window.

In some embodiments, the RLF information includes at least an indication indicating a time difference between two measurement-based events among the at least one measurement-based event which are fulfilled within the time window in response to the fact that at least two measurement-based events are configured.

It is appreciated that the RLF information may include other information and/or indication not mentioned above, as long as it does not violate the spirit of the present disclosure.

According to the present disclosure, the time difference may be used by the network to analysis why a CHO cannot be performed even the two measurement-based events are fulfilled one after another when the time-based event is met, and the network may perform MRO to increase the successful rate of CHO.

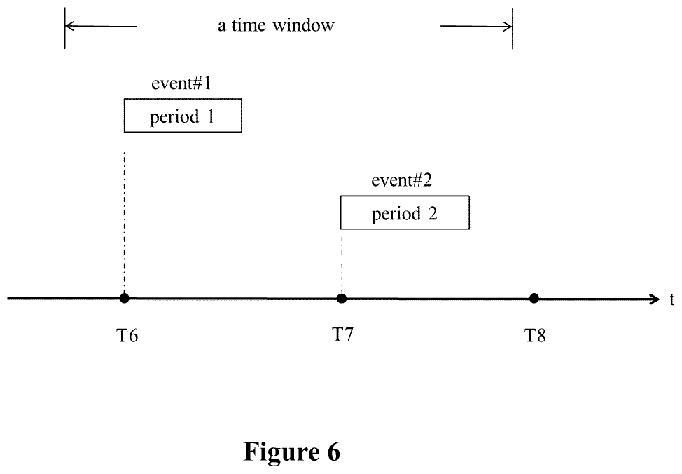

For example as shown in FIG. 6, the CHO execution condition for a target cell includes two measurement-based events (event #1 and event #2). In the time window, event #1 is fulfilled in period 1 starting at time point T6, event #2 is fulfilled in period 2 starting at time point T7; there is no overlap between period 1 and period 2,i.e., event #1 and event #2 are not fulfilled simultaneously within the time window, accordingly, the UE does not perform CHO. At time point T8, an RLF occurs. Although in FIG. 6, T8 is later than the time window, it would be appreciated that, according to the present disclosure, T8 may be within the time window either. In this example, the time difference is (T7−T6).

In some embodiments, the RLF information includes at least measurement results at the end of the time window.

In some cases, in operation 510, the CHO execution condition includes a location-based event and at least one measurement-based event, the location-based event is fulfilled if the UE is within the configured location.

In some embodiments, the RLF information includes at least an indication indicating whether the at least one measurement-based event is fulfilled or not fulfilled when the UE is within a configured location.

In some embodiments, the RLF information includes at least at least one satisfied measurement-based event when the UE is within the configured location.

In some embodiments, the RLF information includes at least an indication indicating whether at least one measurement-based event is fulfilled or not fulfilled before the UE enters the configured location.

In some embodiments, the RLF information includes at least an indication indicating whether at least one measurement-based event is fulfilled or not fulfilled after the UE leaves the configured location.

In some embodiments, the RLF information includes at least an indication indicating a time difference between two measurement-based events among the at least one measurement-based event which are fulfilled when the UE is within the configured location in response to the fact that at least two measurement-based events are configured. According to the present disclosure, the time difference may be used by the network to analysis why a CHO cannot be performed even the two measurement-based events are fulfilled one after another when the location-based event is met, and the network may perform MRO to increase the successful rate of CHO.

In some embodiments, the RLF information includes at least measurement results when the UE leaves the configured location.

It is appreciated that the RLF information may include other information and/or indication not mentioned above, as long as it does not violate the spirit of the present disclosure.

According to the present disclosure, to further strength the MRO functionality of a network, the UE is further configured to report SHR information after a CHO or an HO.

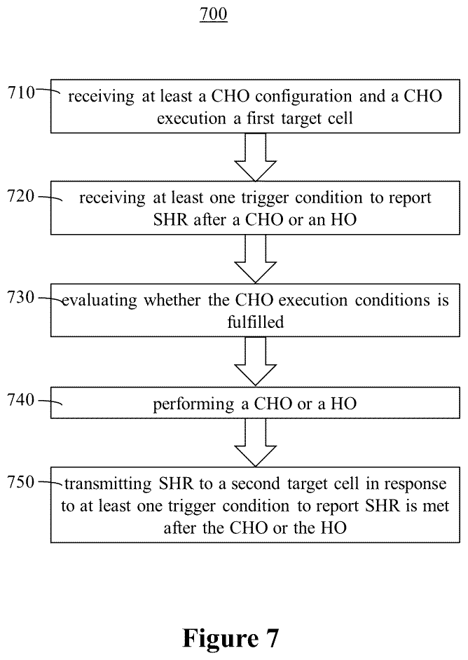

FIG. 7 illustrates method 700 performed by a UE based on method 100 according to some embodiments of the present disclosure. It would be appreciated that in method 700, the UE is not a special UE; it can be a generic device or an apparatus, or a part of a device or an apparatus that uses the technical solution of the present application.

In operation 710, the UE receives at least a CHO configuration and a CHO execution condition for a first target cell. In some embodiments, the CHO execution condition includes a time-based event and at least one measurement-based event. In some embodiments, the CHO execution condition includes a location-based event and at least one measurement-based event.

In operation 720, the UE further receives at least one SHR trigger condition to report SHR after a CHO or an HO.

According to the present disclosure, in the case that the at least one SHR trigger condition to report SHR includes at least two trigger conditions, if one or more of the at least one SHR trigger condition are fulfilled during the CHO or the HO, the UE may transmit SHR after the CHO or the HO.

In operation 730, the UE evaluates whether the CHO execution condition is fulfilled.

In some embodiments, the CHO execution condition includes a time-based event and at least one measurement-based event, the UE determines that the CHO execution condition is fulfilled only when both the time-based event and the at least one measurement-based event are fulfilled; wherein, if the at least one measurement-based events includes more than one measurement-based events, then the at least one measurement-based event is determined to be fulfilled only when all of the more than one measurement-based events are fulfilled simultaneously.

In some embodiments, the CHO execution condition includes a location-based event and at least one measurement-based event, the UE determines that the CHO execution condition is fulfilled only when both the location-based event and the at least one measurement-based event are fulfilled; wherein, if the at least one measurement-based events includes more than one measurement-based events, then the at least one measurement-based event is determined to be fulfilled only when all of the more than one measurement-based events are fulfilled simultaneously.

In operation 740, the UE performs a CHO if the CHO execution condition is met, or performs an HO if the UE receives an HO command and certain requirements are fulfilled.

In operation 750, if one or more of the at least one SHR trigger conditions to report SHR are fulfilled during the CHO or the HO, the UE transmits SHR to a second target cell after accessing to the second target cell. If the UE perform a CHO in response to the fact that the CHO execution condition is met, the second target cell is the first target cell. If the UE performs an HO in response to receiving an HO command, the second target cell may be the same first target cell, or may be a different target cell.

According to the present disclosure, after the second target cell receives the SHR, it may forward the SHR or part of the SHR via an access and mobility indication to the source cell on an Xn interface. The access and mobility indication is used to transfer access and mobility related information between two BSs. The network (including the source cell and the second target BS) may analyze the SHR for MRO.

In some cases, in operation 710, the CHO execution condition includes a time-based event and at least one measurement-based event, the at least one SHR trigger condition to report SHR after a CHO or an HO may include at least one of:
a physical layer problem timer being running at the beginning of a time window corresponding to the time-based event;
an elapsed time value of the physical layer problem timer being greater than a third threshold multiplied with a first configured value for the physical layer problem timer when the time-based event is fulfilled;
a timer for initiating failure recovery based on triggering a measurement report being running at the beginning of the time window;
an elapsed time value of the timer for initiating failure recovery based on triggering a measurement report being greater than a fourth threshold multiplied with a second configured value for the timer for initiating failure recovery based on triggering the measurement report when the timer-based event being fulfilled; or
a time difference between two measurement-based events among the at least one measurement-based event which are fulfilled within the time window exceeding a fifth threshold in response to the fact that at least two measurement-based events are configured.

It is appreciated that the at least one SHR trigger condition may include other SHR trigger condition not mentioned above, as long as it does not violate the spirit of the present disclosure.

In some embodiments, if any one or more of the at least one SHR trigger condition are met, the UE may transmit SHR after HO or CHO.

In some embodiments, the SHR may include at least an indication indicating whether the physical layer problem timer is running at the beginning at the time window.

In some embodiments, the SHR may include at least an indication indicating whether the timer for initiating failure recovery based on triggering the measurement report is running at the beginning of the time window.

In some embodiments, the SHR may include at least an indication indicating whether the physical layer problem timer is running at the end of the time window.

In some embodiments, the SHR may include at least an indication indicating whether the timer for initiating failure recovery based on triggering the measurement report is running at the end of the time window.

In some embodiments, the SHR may include at least one SHR condition fulfilled after the HO or the CHO is performed.

In some embodiments, the SHR may include at least an indication indicating whether the at least one measurement-based event is fulfilled or not fulfilled within the time window.

In some embodiments, the SHR may include at least an indication indicating whether the at least one measurement-based event is fulfilled or not fulfilled before the time window.

In some embodiments, the SHR may include at least an indication indicating whether the at least one measurement-based event is fulfilled or not fulfilled after the time window.

In some embodiments, the SHR information includes at least an indication indicating a time difference between two measurement-based events among the at least one measurement-based event which are fulfilled within the time window in response to the fact that at least two measurement-based events are configured. According to the present disclosure, the time difference may be used by the network to improve MRO functionality, for example, to further increase the successful rate of CHO.

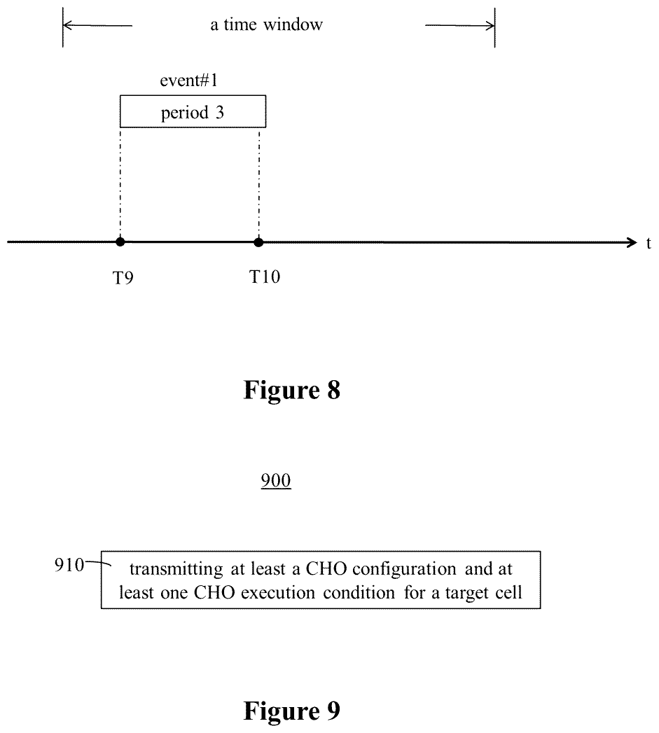

For example as shown in FIG. 8, the CHO execution condition for a target cell includes two measurement-based events (event #1 and event #2). In the time window, event #1 is fulfilled at least during period 3, wherein period 3 starts at time point T9 and includes time pint T10, event #2 starts to be fulfilled at time point T10; in other words, event #1 and event #2 are fulfilled simultaneously at time point T10 within the time window; accordingly, the UE perform a CHO. In this example, the time difference is (T10−T9).

In some embodiments, the SHR may include at least measurement results when performing CHO or HO.

It is appreciated that the SHR may include other information and/or indication not mentioned above, as long as it does not violate the spirit of the present disclosure.

In some cases, in operation 710, the CHO execution condition includes a location-based event and at least one measurement-based event, wherein the location-based event is fulfilled if the UE is within the configured location. The at least one SHR trigger condition to report SHR after a CHO or an HO may include at least one of:
a physical layer problem timer running when entering the configured location;
an elapsed time value of the physical layer problem timer being greater than a third threshold multiplied with a first configured value for the physical layer problem timer when the location-based event is fulfilled;
a timer for initiating failure recovery based on triggering a measurement report running when entering the configured location;
an elapsed time value of the timer for initiating failure recovery based on triggering a measurement report being greater than a fourth threshold multiplied with a second configured value for the timer for initiating failure recovery based on triggering the measurement report when the location-based event is fulfilled; or
a time difference between two measurement-based events among the at least one measurement-based event which are fulfilled within the time window exceeding a fifth threshold in response to the fact that at least two measurement-based events are configured.

It is appreciated that the at least one SHR trigger condition may include other SHR trigger condition not mentioned above, as long as it does not violate the spirit of the present disclosure.

In some embodiments, if any one or more of the at least one SHR trigger condition are met, the UE may transmit SHR after HO or CHO.

In some embodiments, the SHR may include at least an indication indicating whether the physical layer problem timer is running when the UE enters the configured location.

In some embodiments, the SHR may include at least an indication indicating whether the timer for initiating failure recovery based on triggering the measurement report is running when the UE enters the configured location.

In some embodiments, the SHR may include at least an indication indicting whether the physical layer problem timer is running when the UE leaves the configured location.

In some embodiments, the SHR may include at least an indication indicting whether the timer for initiating failure recovery based on triggering the measurement report is running when the UE leaves the configured location.

In some embodiments, the SHR may include at least one SHR condition fulfilled after the HO or the CHO is performed.

In some embodiments, the SHR may include at least an indication indicating whether the at least one measurement-based event is fulfilled or not fulfilled when the UE is within the configured location.

In some embodiments, the SHR may include at least an indication indicating at least one measurement-based event is fulfilled or not fulfilled before the UE enters the configured location.

In some embodiments, the SHR may include at least an indication indicating at least one measurement-based event is fulfilled or not fulfilled after the UE leaves the configured location.

In some embodiments, the SHR information includes at least an indication indicating a time difference between two measurement-based events among the at least one measurement-based event which are fulfilled when the UE is within the configured location in response to the fact that at least two measurement-based events are configured. According to the present disclosure, the time difference may be used by the network to improve MRO functionality, for example, to further increase the successful rate of CHO.

In some embodiments, the SHR may include at least measurement results when performing CHO or HO.

It is appreciated that the SHR may include other information and/or indication not mentioned above, as long as it does not violate the spirit of the present disclosure.

Various methods and embodiments are described above for a UE to perform according to the present disclosure. It would be appreciated that a source BS and/or a target BS may perform corresponding methods according to the present disclosure.

FIG. 9 illustrates an exemplary flowchart of method 900 performed by a source BS or a serving BS according to some embodiments of the present disclosure. It would be appreciated that in method 900, the BS is not a special BS; it can be a generic device or an apparatus, or a node, or a part of a device or an apparatus or a node that uses the technical solution of the present application.

In operation 910, the BS transmits at least a CHO configuration and a CHO execution condition for a target cell. In some embodiments, the CHO execution condition includes a time-based event and at least one measurement-based event. In some embodiments, the CHO execution condition includes a location-based event and at least one measurement-based event. In some embodiments, the CHO execution condition and the CHO configuration are included in a reconfiguration message, e.g., RRC reconfiguration message.

In some embodiments, the BS transmits the CHO execution condition via a Radio Resource Control (RRC) reconfiguration message, e.g., RRCReconfiguration.

In some embodiment, each of the at least one measurement-based event is CondEvent A3, CondEvent A4, or CondEvent A5.

For example, the at least one measurement-based event may include only one measurement-based event, and the measurement-based event is a CondEvent A3, a CondEvent A4, or a CondEvent A5.

For example, the at least one measurement-based event may include two measurement-based events, and the two measurement-based events may be a CondEvent A3 and a CondEvent A5.

For example, the at least one measurement-based event may include two measurement-based events, and the two measurement-based events may be a CondEvent A3 based on RSRP and a CondEvent A3 based on a ratio between RSRP and RSSI.

In some embodiment, method 100 further includes transmitting an HO command to the UE.

In some embodiments, if the CHO execution condition includes a time-based event and at least one measurement-based event, the time-based event is fulfilled if a current time is within a time window. If the at least one measurement-based event is fulfilled within the time window, it means that the CHO execution condition is fulfilled.

In some embodiments, the UE may perform CHO according to a received CHO configuration if the at least one measurement-based event is fulfilled within the time window.

In some embodiments, the time window is configured as a first threshold (T1) for a beginning of the time window and a CHO timer, as illustrated in FIG. 2(a), wherein the CHO timer has a configured length. In some embodiments, the configured length is set via an RRC reconfiguration message.

In some embodiments, the time window is configured as a first threshold (T1) for a beginning of the time window and a duration of the time window, as illustrated in FIG. 3(a), wherein the duration has a configured duration value. In some embodiments, the configured duration value is set via an RRC reconfiguration message.

In some embodiments, the time window is configured as a first threshold (T1) for the beginning of the time window and a second threshold (T5) associated with an end of the time window, as illustrated in FIG. 4(a), wherein the time window is between T1 and T5, and the length of the time window is a time difference between T1 and T5. The time-based event is fulfilled when a current time is within the time window.

In some embodiments, method 900 may further include receiving an indication indicating that a time point where the UE receives a time-based event is later than the first threshold, if the CHO execution condition includes the time-based event and at least one measurement-based event. In some embodiments, the indication is received via an RRC reconfiguration complete message.

In some embodiments, method 900 may further include transmitting at least one SHR trigger conditions to report SHR to a UE.

In the case that the CHO execution condition includes a time-based event and at least one measurement-based event, the at least one SHR trigger condition to report SHR includes at least one of:
a physical layer problem timer being running at a beginning of the time window;
an elapsed time value of the physical layer problem timer being greater than a third threshold multiplied with a first configured value for the physical layer problem timer when the time-based event is fulfilled;
a timer for initiating failure recovery based on triggering a measurement report being running at the beginning of time window;
an elapsed time value of the timer for initiating failure recovery based on triggering a measurement report being greater than a fourth threshold multiplied with a second configured value for the timer for initiating failure recovery based on triggering the measurement report when the time-based event is fulfilled; or
a time difference between two measurement-based events among the at least one measurement-based event which are fulfilled within the time window exceeding a fifth threshold in response to the fact that at least two measurement-based events are configured.

In the case that the CHO execution condition includes a location-based event and at least one measurement-based event, the at least one SHR trigger condition to report SHR includes at least one of:
a physical layer problem timer being running when entering the configured location;
an elapsed time value of the physical layer problem timer being greater than a third threshold multiplied with a first configured value for the physical layer problem timer when the location-based event is fulfilled;
a timer for initiating failure recovery based on triggering a measurement report being running when entering the configured location;
an elapsed time value of the timer for initiating failure recovery based on triggering a measurement report being greater than a fourth threshold multiplied with a second configured value for the timer for initiating failure recovery based on triggering the measurement report when the location-based event is fulfilled; or
a time difference between two measurement-based events among the at least one measurement-based event which are fulfilled within the time window exceeding a fifth threshold in response to the fact that at least two measurement-based events are configured.

It would be appreciated in the provided methods and embodiments provided by the present disclosure, the number of each operation does not represent the order of execution. For example, in FIG. 700, operation 720 may be executed before operation 710, or operation 720 and operation 710 may be executed simultaneously.

The present disclosure provides various methods and embodiments for CHO in a NTN in the cases that the time that the UE receives a time window configuration corresponding to a time-based event is later than the start time of the time window.

The present disclosure designs the entry condition and leaving condition for a time-based event for CHO in a NTN.

The present disclosure provide more information in RLF report or in SHR regarding to the CHO execution condition combining time and measurement or combining location and measurement to strength the MRO of the NTN.

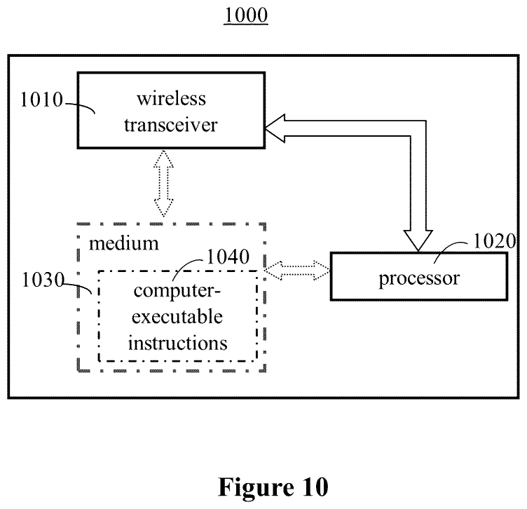

FIG. 10 illustrates a simplified block diagram of an exemplary apparatus 1000 according to various embodiments of the present disclosure.

In some embodiments, apparatus 1000 may be or include at least a part of a UE or similar device having similar functionality.

In some embodiments, apparatus 1000 may be or include at least a part of a BS or similar device having similar functionality.

As shown in FIG. 10, apparatus 1000 may include at least wireless transceiver 1010 and processor 1020, wherein wireless transceiver 1010 may be coupled to processor 1020. Furthermore, apparatus 1000 may include non-transitory computer-readable medium 1030 with computer-executable instructions 1040 stored thereon, wherein non-transitory computer-readable medium 1030 may be coupled to processor 1020, and computer-executable instructions 1040 may be configured to be executable by processor 1020. In some embodiments, wireless transceiver 1010, non-transitory computer-readable medium 1030, and processor 1020 may be coupled to each other via one or more local buses.

Although in FIG. 10, elements such as wireless transceiver 1010, non-transitory computer-readable medium 1030, and processor 1020 are described in the singular, the plural is contemplated unless limitation to the singular is explicitly stated. In some embodiments of the present disclosure, wireless transceiver 1010 may be configured for wireless communication. In some embodiments of the present disclosure, wireless transceiver 1010 can be integrated into a transceiver. In certain embodiments of the present disclosure, the apparatus 1000 may further include other components for actual usage.

In some embodiments that the apparatus 1000 is a UE or at least a part of a UE, Processor 1020 is configured to cause the apparatus 1000 at least to perform, with wireless transceiver 1010, any method described above which is performed by a UE according to the present disclosure.

Processor 1020 is configured to, receive, with wireless transceiver 1010, at least a CHO configuration and a CHO execution condition for a target cell, wherein the CHO execution condition includes: a time-based event and at least one measurement-based event, or a location-based event and at least one measurement-based event; and evaluate whether the CHO execution condition is fulfilled.

In some embodiments, each of the at least one measurement-based event is CondEvent A3, CondEvent A4, or CondEvent A5.

In some embodiments, the CHO execution condition includes the time-based event and the at least one measurement-based event, the time-based event corresponds to a time window, and the time-based event is fulfilled if a current time is within the time window, wherein the time window is configured as:
a first threshold for a beginning of the time window and a CHO timer, wherein a length of the CHO timer is equal to a length of the time window;
a first threshold for a beginning of the time window and a duration of the time window; or
a first threshold for a beginning of the time window and a second threshold associated with an end of the time window.

In some embodiments, in response to the fact that the time window is configured as the first threshold and the duration, the time-based event further comprises an entry condition, wherein: the entry condition for the time-based event is an inequality that a current time is greater than the first threshold and the current time is less than the first threshold plus a configured duration value.

In some embodiments, in response to the fact that the time window is configured as the first threshold and the duration, the time-based event further comprises a leaving condition, wherein: the leaving condition for the time-based event is an inequality that a current time is less than the first threshold or the current time is greater than the first threshold plus a configured duration value.

In some embodiments, in response to the fact that the time window is configured as the first threshold and the second threshold, the time-based event further comprises an entry condition, wherein: the entry condition for the time-based event is an inequality that a current time is greater than the first threshold and the current time is less than the second threshold.

In some embodiments, in response to the fact that the time window is configured as the first threshold and the second threshold, the time-based event further comprises a leaving condition, wherein: the leaving condition for the time-based event is an inequality that a current time is less than the first threshold or the current time is greater than the second threshold.

In some embodiment, in response to the fact that the time window is configured as the first threshold for the beginning of time window and the CHO timer, processor 1020 is further configured to: in response to the fact that a time point of receiving the first threshold is greater than the first threshold of the beginning of time window, start the CHO timer.

In some embodiments, in response to the fact that the time point of receiving the first threshold is greater than the first threshold of the beginning of the time window, processor 1020 is further configured to set a length of the CHO timer as one of: a configured length of the CHO timer minus a time difference between the first threshold and the time point; and the configured length of the CHO timer.

In some embodiments, in response to the fact that the time window is configured as the first threshold for the beginning of the time window and the CHO timer, the time point of receiving the first threshold is greater than the first threshold of the time window, processor 1020 is further configured to: not starting the CHO timer, or start the CHO timer and immediately stop the CHO timer.

In some embodiments, in response to the fact that the time window is configured as the first threshold for the beginning of the time window and the duration of the time window, or the time window is configured as the first threshold for the beginning of the time window and the second threshold associated with the end of the time window, the time-based event further comprises an entry condition and/or a leaving condition.

In some embodiments, to evaluate whether the time-based event is fulfilled, processor 1020 is further configured to: determine the time-based event is fulfilled in response to the fact that the entry condition is fulfilled and/or the leaving condition is not fulfilled.

In some embodiments, processor 1020 is further configured to: in response to the fact that a time point of receiving the first threshold is greater than the first threshold, set the duration as one of: a configured duration value minus a time difference between the first threshold and the time point, and a configured duration value.

In some embodiments, in response to the fact that the time point of receiving the first threshold is greater than the first threshold, processor 1020 is further configured to: ignore the CHO execution condition; and discard the CHO execution condition and keeping the CHO configuration.

In some embodiments, in response to the fact that the time point of receiving the first threshold is greater than the first threshold, processor 1020 is further configured to transmit, with wireless transceiver 1010, an indication to indicate that the time point is greater than the first threshold.

In some embodiments, wherein the indication is transmitted via a reconfiguration complete message.

In some embodiments, processor 1020 is further configured to declare an RLF if the RLF occurs; perform a re-establishment procedure due to the RLF; and transmit RLF information to a re-established cell.

If the CHO execution condition includes a time-base event and at least one measurement-based event, the RLF information includes at least one of:
an indication indicating whether at least one measurement-based event is fulfilled or not fulfilled within the time window;
at least one satisfied measurement-based event within the time window;
an indication indicating whether at least one measurement-based event is fulfilled or not fulfilled before the time window;
an indication indicating whether at least one measurement-based event is fulfilled or not fulfilled later than the time window;
an indication indicating a time difference between two measurement-based events among the at least one measurement-based event which are fulfilled within the time window in response to the fact that at least two measurement-based events are configured; or
measurement results at the end of the time window.

If the CHO execution condition includes a location-based event and at least one measurement-based event, the RLF information includes at least one of:
an indication indicating whether at least one measurement-based event is fulfilled or not fulfilled when the UE is within a configured location;
at least one satisfied measurement-based event when the UE is within the configured location;
an indication indicating whether at least one measurement-based event is fulfilled or not fulfilled before the UE enters the configured location;
an indication indicating whether at least one measurement-based event is fulfilled after the UE leaves the configured location;
an indication indicating a time difference between two measurement-based events among the at least one measurement-based event which are fulfilled when the UE is within the configured location in response to the fact that at least two measurement-based events are configured; or
measurement results when the UE leaves the configured location, wherein the location-based event is fulfilled if the UE is within the configured location.

In some embodiments, processor 1020 is further configured to receive, with wireless transceiver 1010, at least one SHR trigger condition to report SHR after a CHO or an HO.

In the cases that the CHO execution condition includes a time-based event and at least one measurement-based events, the at least one SHR condition includes at least one of:
a physical layer problem timer being running at a beginning of the time window;
an elapsed time value of the physical layer problem timer being greater than a third threshold multiplied with a first configured value for the physical layer problem timer when the time-based event is fulfilled;
a timer for initiating failure recovery based on triggering a measurement report being running at the beginning of the time window;
an elapsed time value of the timer for initiating failure recovery based on triggering a measurement report being greater than a fourth threshold multiplied with a second configured value for the timer for initiating failure recovery based on triggering the measurement report when the timer-based event being fulfilled; or.
a time difference between two measurement-based events among the at least one measurement-based event which are fulfilled within the time window exceeding a fifth threshold in response to the fact that at least two measurement-based events are configured.

In some embodiments, processor 1020 is further configured to perform an HO or a CHO; and in response to that at least one SHR trigger condition to report SHR is fulfilled, reporting the SHR to a target cell.

If the CHO execution condition includes a time-base event and at least one measurement-based event, the SHR includes at least one of:
an indication indicating whether the physical layer problem timer is running at the beginning of the time window;
an indication indicating whether the timer for initiating failure recovery based on triggering the measurement report is running at the beginning of the time window;
an indication indicating whether the physical layer problem timer is running at the end of the time window;
an indication indicating whether the timer for initiating failure recovery based on triggering the measurement report is running at the end of the time window;
at least one SHR condition fulfilled after the HO or the CHO is performed;
an indication indicating whether the at least one measurement-based condition is fulfilled or not fulfilled within the time window;
an indication indicating whether the at least one measurement-based event is fulfilled or not fulfilled before the time window;
an indication indicating whether the at least one measurement-based event is fulfilled or not fulfilled after the time window;
an indication indicating a time difference between two measurement-based events among the at least one measurement-based event which are fulfilled within the time window in response to the fact that at least two measurement-based events are configured; or.
measurement results when performing CHO or HO.

In the cases that the CHO execution condition includes a location-based event and at least one measurement-based events, the at least one SHR trigger condition includes at least one of:
a physical layer problem timer being running when entering the configured location;
an elapsed time value of the physical layer problem timer being greater than a third threshold multiplied with a first configured value for the physical layer problem timer when the location-based event is fulfilled;
a timer for initiating failure recovery based on triggering a measurement report being running when entering the configured location;
an elapsed time value of the timer for initiating failure recovery based on triggering a measurement report being greater than a fourth threshold multiplied with a second configured value for the timer for initiating failure recovery based on triggering the measurement report when the location-based event is fulfilled; or
a time difference between two measurement-based events among the at least one measurement-based event which are fulfilled within the time window exceeding a fifth threshold in response to the fact that at least two measurement-based events are configured.

If the CHO execution condition includes a location-based event and at least one measurement-based event, the SHR includes at least one of:
an indication indicating whether the physical layer problem timer is running when the UE enters the configured location;
an indication indicating whether the timer for initiating failure recovery based on triggering the measurement report is running when the UE enters the configured location;
an indication indicting whether the physical layer problem timer is running when the UE leaves the configured location;
an indication indicating whether the timer for initiating failure recovery based on triggering the measurement report is running when the UE leaves the configured location;
at least one SHR condition fulfilled after the HO or the CHO is performed;
an indication indicating whether the at least one measurement-based event is fulfilled or not fulfilled when the UE is within the configured location;
an indication indicating at least one measurement-based event is fulfilled or not fulfilled before the UE enters the configured location;
an indication indicating at least one measurement-based event is fulfilled or not fulfilled after the UE leaves the configured location;
an indication indicating a time difference between two measurement-based events among the at least one measurement-based event which are fulfilled when the UE is within the configured location in response to that at least two measurement-based events are configured; or
measurement results when the UE performs CHO or HO, wherein the location-based event is fulfilled if the UE is within the configured location.

In some embodiments that the apparatus 1000 is a BS or at least a part of a BS, Processor 1020 is configured to cause the apparatus 1000 at least to perform, with wireless transceiver 1010, any method described above which is performed by a BS according to the present disclosure.

Processor 1020 is configured to transmit, with wireless transceiver 1010, at least a CHO configuration and a CHO execution condition for a target cell, wherein the CHO execution condition includes: a time-based event and at least one measurement-based event; or a location-based event and at least one measurement-based event.

In some embodiments, each of the at least one measurement-based event is CondEvent A3, CondEvent A4, or CondEvent A5.

In some embodiments, the CHO execution condition includes the time-based event and the at least one measurement-based event, the time-based event is fulfilled if a current time is within a time window, wherein the time window is configured as:
a first threshold and a CHO timer with a length;
a first threshold and a duration; or
a first threshold and a second threshold.

In some embodiments, processor 1020 is further configured to receive, with wireless transceiver 1010, an indication indicating that a time point where the UE receives the first threshold is later than the first threshold.

In some embodiments, the indication is received via a reconfiguration complete message.

In some embodiments, processor 1020 is further configured to transmit, with wireless transceiver 1010, at least one SHR trigger condition to report SHR after a CHO or an HO.

If the CHO execution condition includes a time-based event and at least one measurement-based event, the at least one SHR trigger condition to report SHR includes at least one of:
a physical layer problem timer being running at a beginning of the time window;
an elapsed time value of the physical layer problem timer being greater than a third threshold multiplied with a first configured value for the physical layer problem timer when the time-based event is fulfilled;
a timer for initiating failure recovery based on triggering a measurement report being running at the beginning of time window;
an elapsed time value of the timer for initiating failure recovery based on triggering a measurement report being greater than a fourth threshold multiplied with a second configured value for the timer for initiating failure recovery based on triggering the measurement report when the time-based event is fulfilled; or
a time difference between two measurement-based events among the at least one measurement-based event which are fulfilled within the time window exceeding a fifth threshold in response to the fact that at least two measurement-based events are configured.

If the CHO execution condition includes a location-based event and at least one measurement-based event, the at least one SHR trigger condition to report SHR includes at least one of:
a physical layer problem timer being running when entering the configured location;
an elapsed time value of the physical layer problem timer being greater than a third threshold multiplied with a first configured value for the physical layer problem timer when the location-based event is fulfilled;
a timer for initiating failure recovery based on triggering a measurement report being running when entering the configured location;
an elapsed time value of the timer for initiating failure recovery based on triggering a measurement report being greater than a fourth threshold multiplied with a second configured value for the timer for initiating failure recovery based on triggering the measurement report when the location-based event is fulfilled; or
a time difference between two measurement-based events among the at least one measurement-based event which are fulfilled within the time window exceeding a fifth threshold in response to the fact that at least two measurement-based events are configured.

In various example embodiments, processor 1020 may include, but is not limited to, at least one hardware processor, including at least one microprocessor such as a CPU, a portion of at least one hardware processor, and any other suitable dedicated processor such as those developed based on for example Field Programmable Gate Array (FPGA) and Application Specific Integrated Circuit (ASIC). Further, processor 1020 may also include at least one other circuitry or element not shown in FIG. 10.

In various example embodiments, non-transitory computer-readable medium 1030 may include at least one storage medium in various forms, such as a volatile memory and/or a non-volatile memory. The volatile memory may include, but is not limited to, for example, an RAM, a cache, and so on. The non-volatile memory may include, but is not limited to, for example, an ROM, a hard disk, a flash memory, and so on. Further, non-transitory computer-readable medium 1030 may include, but is not limited to, an electric, a magnetic, an optical, an electromagnetic, an infrared, or a semiconductor system, apparatus, or device or any combination of the above.

Further, in various example embodiments, exemplary apparatus 1000 may also include at least one other circuitry, element, and interface, for example antenna element, and the like.

In various example embodiments, the circuitries, parts, elements, and interfaces in exemplary apparatus 1000, including processor 1020 and non-transitory computer-readable medium 1030, may be coupled together via any suitable connections including, but not limited to, buses, crossbars, wiring and/or wireless lines, in any suitable ways, for example electrically, magnetically, optically, electromagnetically, and the like.

The methods of the present disclosure can be implemented on a programmed processor. However, controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device that has a finite state machine capable of implementing the flowcharts shown in the figures may be used to implement the processing functions of the present disclosure.

While the present disclosure has been described with specific embodiments thereof, it is evident that many alternatives, modifications, and variations will be apparent to those skilled in the art. For example, various components of the embodiments may be interchanged, added, or substituted in other embodiments. Also, all of the elements shown in each figure are not necessary for operation of the disclosed embodiments. For example, one skilled in the art of the disclosed embodiments would be capable of making and using the teachings of the present disclosure by simply employing the elements of the independent claims. Accordingly, the embodiments of the present disclosure as set forth herein are intended to be illustrative, not limiting. Various changes may be made without departing from the spirit and scope of the present disclosure.

The terms “includes,” “comprising,” “includes,” “including,” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The terms “including,” “having,” and the like, as used herein, are defined as “comprising.”

1. A user equipment (UE) comprising:
at least one memory; and
at least one processor
coupled with the at least one memory and configured to cause the UE to:
receive at least a conditional handover (CHO) configuration and a CHO execution condition for a target cell, wherein the CHO execution condition includes:
a time-based event and at least one measurement-based event, or
a location-based event and at least one measurement-based event; and
evaluate whether the CHO execution condition is fulfilled.

2. The UE of claim 1, wherein the at least one measurement-based event is CondEvent A3, CondEvent A4, or CondEvent A5.

3. The UE of claim 1, wherein the CHO execution condition includes the time-based event and the at least one measurement-based event, the time-based event corresponds to a time window, wherein the time window is configured as:
a first threshold for a beginning of the time window and a CHO timer, wherein a length of the CHO timer is equal to a length of the time window;
a first threshold for a beginning of the time window and a duration of the time window; or
a first threshold for a beginning of the time window and a second threshold associated with an end of the time window.

4. The UE of claim 3, wherein, when the time window is configured as the first threshold and the duration, the time-based event further comprises an entry condition, wherein:
the entry condition for the time-based event is an inequality that a current time is greater than the first threshold and the current time is less than the first threshold plus a configured duration value.

5. The UE of claim 3, wherein, when the time window is configured as the first threshold and the duration, the time-based event further comprises a leaving condition, wherein:
the leaving condition for the time-based event is an inequality that a current time is less than the first threshold or the current time is greater than the first threshold plus the configured duration value.

6. The UE of claim 3, wherein, when the time window is configured as the first threshold and the second threshold, the time-based event further comprises an entry condition, wherein:
the entry condition for the time-based event is an inequality that a current time is greater than the first threshold and the current time is less than the second threshold.

7. The UE of claim 3, wherein, when the time window is configured as the first threshold and the second threshold, the time-based event further comprises a leaving condition, wherein:
the leaving condition for the time-based event is an inequality that a current time is less than the first threshold or the current time is greater than the second threshold.

8. The UE of claim 3, wherein, when the time window is configured as the first threshold for the beginning of time window and the CHO timer, the at least one processor is further configured to cause the UE to:
when a time point of receiving the first threshold is greater than the first threshold of the beginning of time window and less than the end of the time window, start the CHO timer.

9. The UE of claim 8, wherein, when the time point of receiving the first threshold is greater than the first threshold of the beginning of the time window, and less than the end of the time window, the at least one processor is further configured to cause the UE to set a length of the CHO timer as:
a configured length of the CHO timer minus a time difference between the first threshold and the time point; or
the configured length of the CHO timer.

10. The UE of claim 3, wherein, when the time window is configured as the first threshold for the beginning of the time window and the CHO timer, the time point of receiving the first threshold is greater than the first threshold of the time window, the at least one processor is further configured to cause the UE to:
not start the CHO timer, or
start the CHO timer and immediately stop the CHO timer.

11. The UE of claim 3, wherein, when the time window is configured as the first threshold for the beginning of the time window and the duration of the time window, or the time window is configured as the first threshold for the beginning of the time window and the second threshold associated with the end of the time window, the time-based event further comprises an entry condition or a leaving condition.

12. The UE of claim 11, wherein, when the time window is configured as the first threshold for the beginning of time window and the duration of the time window, to evaluate whether the time-based event is fulfilled, the at least one processor is further configured to cause the UE to:
determine the time-based event is fulfilled when the entry condition is fulfilled or the leaving condition is not fulfilled.

13. The UE of claim 3, wherein the at least one processor is further configured to cause the UE to:
when a time point of receiving the first threshold is greater than the first threshold, set the duration as:
a configured duration value minus a time difference between the first threshold and the time point, or
a configured duration value.

14. The UE of claim 3, wherein, when the time point of receiving the first threshold is greater than the first threshold, the at least one processor is further configured to cause the UE to:
ignore the CHO execution condition; and
discard the CHO execution condition and keep the CHO configuration.

15. The UE of claim 3, wherein, when the time point of receiving the first threshold is greater than the first threshold, the at least one processor is further configured to cause the UE to:
transmit an indication that the time point is greater than the first threshold.

16. A processor for wireless communication, comprising:
at least one controller coupled with at least one memory and configured to cause the processor to:
receive at least a conditional handover (CHO) configuration and a CHO execution condition for a target cell,
wherein the CHO execution condition includes:
a time-based event and at least one measurement-based event, or
a location-based event and at least one measurement-based event; and
evaluate whether the CHO execution condition is fulfilled.

17. The processor of claim 16, wherein the CHO execution condition includes the time-based event and the at least one measurement-based event, the time-based event corresponds to a time window,
wherein the time window is configured as:
a first threshold for a beginning of the time window and a CHO timer, wherein a length of the CHO timer is equal to a length of the time window;
a first threshold for a beginning of the time window and a duration of the time window; or
a first threshold for a beginning of the time window and a second threshold associated with an end of the time window.

18. A method performed by a user equipment (UE), the method comprising:
receiving at least a conditional handover (CHO) configuration and a CHO execution condition for a target cell,
wherein the CHO execution condition includes:
a time-based event and at least one measurement-based event, or
a location-based event and at least one measurement-based event; and
evaluating whether the CHO execution condition is fulfilled.

19. A base station (BS), comprising:
at least one memory; and
at least one processor coupled with the at least one memory and configured to cause the BS to:
transmit a reconfiguration message including at least a conditional handover (CHO) configuration and a CHO execution condition for a target cell,
wherein the CHO execution condition includes:
a time-based event and at least one measurement-based event; or
a location-based event and at least one measurement-based event.

20. The BS of claim 19, wherein the least one measurement-based event comprises CondEvent A3, CondEvent A4, or CondEvent A5.
